(19) United States
(12) Patent Application Publication
(10) Pub. No.: US 2008/0165715 A1
(43) Pub. Date: Jul. 10, 2008

(54) WLAN SYSTEMS HAVING REDUCED POWER CONSUMPTION BY DYNAMIC SETTING AND RELATED METHODS THEREOF

(76) Inventor: Tai-Cheng Liu, Hsin-Chu Hsien (TW)

Correspondence Address: NORTH AMERICA INTELLECTUAL PROPERTY CORPORATION, P.O. BOX 506, MERRIFIELD, VA, 22116, US

(21) Appl. No.: 11/621,120

(22) Filed: Jan. 9, 2007

(51) Int. Cl. G08C 17/00; H04Q 7/24

(52) U.S. Cl. 370/311; 370/338

(57) ABSTRACT

A WLAN system is disclosed. The system includes: an Analog Front-End (AFE) circuit, for converting between analog baseband data and digital baseband data; a Radio Frequency (RF) circuit, coupled to the AFE circuit, for converting between analog RF data and analog baseband data; and a baseband circuit, coupled to the AFE circuit, for processing the digital baseband data and dynamically setting at least a parameter of the WLAN system based on the content of the data, in order to control the power consumption level of the WLAN system.

### BACKGROUND

The disclosed invention relates to WLAN systems, and more particularly, to WLAN systems that have reduced power consumption during an active transceiving mode and related methods thereof.

A conventional wireless local area network (WLAN) system is divided into a front-end section and a back-end section. The front-end section comprises an RF circuit, for converting RF signals to baseband signals in receiving (Rx) mode, and for converting baseband signals to RF signals in transmitting (Tx) mode. The front-end section further comprises an analog front-end (AFE) circuit for converting analog baseband signals to digital baseband data in Rx mode and converting digital baseband data to analog baseband signals in Tx mode. The back-end section comprises a baseband circuit, containing a Medium Access Controller (MAC) for processing the digital baseband signal and packet data.

Data packets of WLAN systems comprise a preamble, a header having information such as the data packet modulation scheme, and the data. The data is typically modulated in one of the modulation schemes: BPSK, QPSK, 8QAM, 16QAM, 64QAM, where BPSK is the lowest modulation and 64QAM is the highest among these modulation schemes. Data transmitted by a more complicated modulation scheme has a higher bit rate, which requires a higher power for receiving the data.

WLAN products are designed to consume as little power as possible, for example, RF and digital parts of an integrated circuit (IC) chip have various reduced power operation modes such as standby mode, sleeping mode, and deep sleeping mode. It normally takes a period of time to switch between a normal mode and a reduced power operation mode, so frequently or immediately switching from the normal mode to the reduced power operation mode is not practical.

### SUMMARY

WLAN systems that can further reduce power consumption are provided. Some embodiments of the WLAN systems have both front-end and baseband circuits integrated on a single chip, which can dynamically adjust some settings of the chip based on the signal format of packets.

A WLAN system comprises a radio frequency (RF) circuit, an analog front-end (AFE) circuit, and a baseband circuit. In some embodiments, the baseband circuit sends a command to dynamically change a setting of the AFE circuit, RF circuit, or both AFE and RF circuits in accordance with a content of the digital baseband data. More specifically, the setting of the AFE or RF circuit can be determined by a transmission rate, modulation type, or a packet type defined in the digital baseband data. For example, when the content of a received packet indicates a low transmission rate, requiring a relatively low signal to noise ratio (SNR), the setting of an analog to digital converter (ADC) in the AFE module and RF Amplifier in the RF module can be dynamically set to make the ADC and RF circuits consume less power. Similarly, when transmitting a packet using a low bit rate modulation scheme (e.g. BPSK), a digital to analog converter (DAC) in the AFE module and RF Amplifier in RF module can be dynamically set to make the DAC and RF circuits consume less power.

In some embodiments, a pre-amplifier or a mixer can be dynamically modified in a transmission mode depending on the transmission rate, and the setting of a low noise amplifier (LNA), mixer, or synthesizer can be dynamically modified in a receiving mode depending on the receiving rate.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a WLAN system according to an embodiment of the disclosed invention.

FIG. 2 is a diagram of a data packet conforming to the 802.11a/g standard.

FIG. 3 is a flowchart for transmitting packets in the WLAN system shown in FIG. 1.

FIG. 4 is a flowchart for receiving packets in the WLAN system shown in FIG. 1.

### DETAILED DESCRIPTION

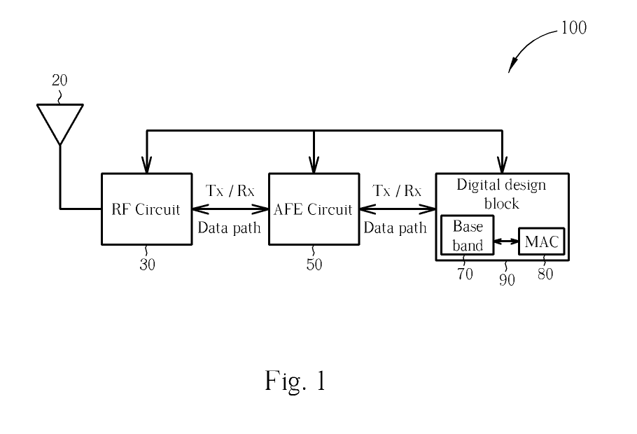

FIG. 1 is a diagram of a WLAN system 100 according to an embodiment of the disclosed invention. The WLAN system 100 is a wireless communication system capable of signal receiving and transmitting, and the WLAN system 100 comprises an RF circuit 30, an AFE circuit 50, and a Digital Design Block 90, comprising a baseband circuit 70, and a Media Access Controller (MAC) 80. The RF circuit 30 is further coupled to an antenna 20.

Data modulated by a modulation scheme with a higher transmission rate requires a higher power setting for receiving or transmitting by the WLAN system 100. This is because the Signal-to-Noise Ratio (SNR) requirement is higher when transmitting or receiving signals carrying more bits in one symbol. The MAC 80 and the baseband circuit 70 can dynamically change the setting of the front-end circuits 30, 50 when a different modulation scheme or a different packet type is transmitted in the transmitting mode or is detected in the receiving mode. This can be achieved by adjusting registers (parameters) of the front-end circuits 30, 50 that influence the amount of power consumed in the WLAN system 100. It should be noted that, in addition to setting the registers, other means for changing the power relevant settings are possible.

In a case where the WLAN system 100 operates under a transmitting (Tx) mode, register setting of a digital-to-analog converter (DAC) in the AFE circuit 50 can be controlled to consume less power when transmitting data using a lower rate modulation scheme. For example, by controlling the reference current fed into the DAC, the resulting SNR level is adjusted accordingly. Regarding the RF circuit 30, register setting of a pre-amplifier, a mixer, or a combination thereof can be controlled to change the resulting SNR level.

In a case where the WLAN system 100 operates under a receiving (Rx) mode, register setting of an analog-to-digital converter (ADC) in the AFE circuit 50 can be controlled to consume less power when receiving data modulated by a lower rate modulation scheme. For example, by controlling the reference current fed into the ADC, the resulting SNR level is adjusted accordingly. Regarding the RF circuit 30, register setting of a low-noise amplifier (LNA), a mixer, a synthesizer, or any combinations thereof can be controlled to change the resulting SNR level. SNR levels required for Tx or Rx, various operation states, operation modes, or data rates are different depending on the design requirements. Additionally, the corresponding register settings of the aforementioned ADC, DAC, LNA, mixer, and synthesizer in response to different SNR levels can be configured according to different design requirements as well. The way of mapping the SNR levels and the register settings of hardware components within the WLAN system 100 is not meant to be a limitation of the present invention. Any alternative designs using the disclosed feature of dynamically setting the RF module or AFE module in response to different transmitting or receiving conditions all fall within the scope of the present invention.

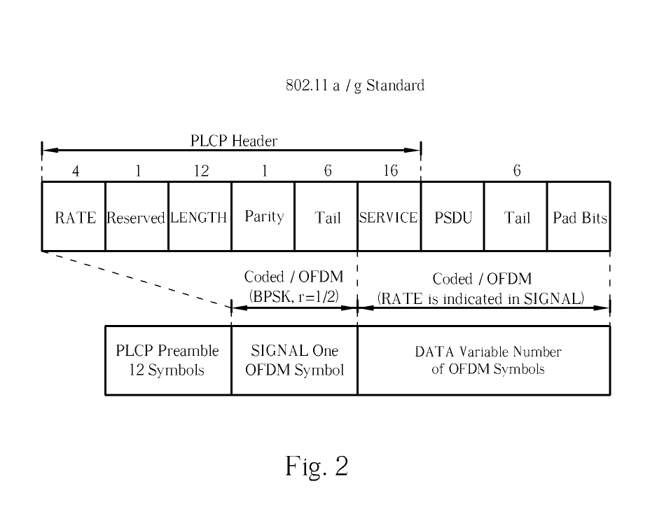

FIG. 2 is a diagram of a data packet conforming to the 802.11a/g standard. As can be seen from the diagram with data lengths shown thereon, the data packet comprises a preamble, a header, and a data section. The preamble and header section of the data packet are modulated with a BPSK modulation scheme. The data packet can be initially received or transmitted at a lower SNR setting, which means the power required by the WLAN system 100 can be reduced, and then the MAC 80 and baseband circuit 70 can dynamically increase the power level by changing the settings of the RF and AFE modules to raise the SNR when receiving or transmitting the preamble or signal.

The detailed operation of the disclosed WLAN system 100 will now be described using examples, with reference to transmitting and receiving methods respectively.

Transmitting (Tx) Mode

Initially, the front-end circuits 30, 50 are at a setting corresponding to a low SNR setting. The WLAN system 100 determines a transmission rate based on the selected modulation scheme. The MAC 80 can dynamically set registers of the front end circuits 30, 50 to a setting corresponding to an appropriate SNR level for data transmission based on the determined transmission rate or modulation scheme. Taking the DAC for example, the DAC setting can be dynamically switched in synchronous with packets. When operating at 11 g OFDM 6 Mbps packet transmission mode, the DAC setting is set to C1 before packet transmission, and when operating at 111 g OFDM 54 Mbps packet transmission mode, the DAC setting is set to D1 before packet transmission, where C1 setting consumes less power than D1 setting. After the data packet is transmitted, if no more data packets are to be transmitted, the MAC 80 will again dynamically set front-end circuit register settings to correspond to the original lowest SNR setting or turn the DAC off for power saving.

Receiving (Rx) Mode

In this example, the WLAN system 100 complies with 802.11g, and can be operated in sleeping mode, packet detection mode, or packet decoding mode. When operating in the sleeping mode, the LNA, mixer, synthesizer in the RF circuit 30 are set to low SNR settings (e.g. A2, A3, A4 respectively), and the ADC 50 is also set to a low SNR setting (e.g. A1 setting) as the system only wakes up for beacon listening at a predetermined time interval. When the system 100 is in the packet detection mode, the packet detection mechanism continuously detects the arrival of a packet. If a packet is detected, the LNA, mixer and synthesizer settings change from A2, A3, A4 to B2, B3, B4 respectively, and the ADC setting changes from A1 to B1 since a higher SNR requirement is needed for later packet decoding. In some embodiments, the packet will be initially received at a low SNR setting corresponding to the BPSK modulation scheme, which is the modulation scheme of the preamble and signal parts of the data packet. At some point during the preamble (e.g. long preamble symbol in 802.11a/g), the MAC 80 will operate to update the register settings of the front-end circuits 30, 50, thereby raising the SNR to a level appropriate for a higher modulation scheme (e.g. 64QAM). After the data packet has been demodulated, the MAC 80 can then operate to change the front-end circuit register settings to correspond to an SNR level appropriate for packet detection. In this way, the WLAN system 100 only operates at maximum power when data in a data packet is actively being received.

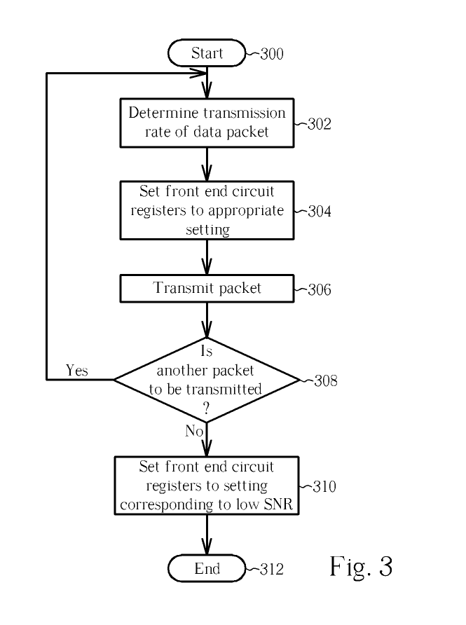

FIG. 3 is a flowchart of an exemplary transmitting method of the WLAN system 100.

The steps are as follows:

Step 300: Start;

Step 302: Determine the transmission rate of the data packet;

Step 304: Set front-end circuit registers to appropriate setting;

Step 306: Transmit the packet;

Step 308: Is another packet to be transmitted? If yes go back to Step 302, if no go to Step 310;

Step 310: Set front-end circuit registers to setting corresponding to low SNR;

Step 312: End.

The WLAN system 100 is initially in a normal transmitting mode (Step 300). The transmission rate of a data packet is determined by the MAC 80 (Step 302) and the WLAN system 100 sets front end circuit registers to a corresponding SNR level setting, so that the higher the transmission rate, the higher the SNR level setting (Step 304). The packet is transmitted at the desired power setting (Step 306). If the WLAN system 100 determines another packet needs to be transmitted (Step 308) then steps 302-306 will be repeated. If not, then the front-end circuit registers 30 and 50 will be reset to the original low power setting (Step 310). The process ends (Step 312).

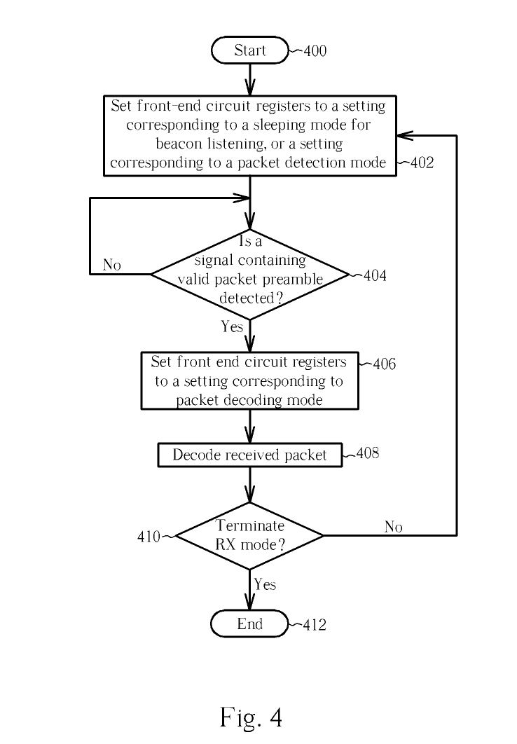

FIG. 4 is a flowchart of an exemplary receiving method of the WLAN system 100. The steps are as follows:

Step 400: Start;

Step 402: Set front-end circuit registers to a setting corresponding to a sleeping mode for beacon listening, or a setting corresponding to a packet detection mode;

Step 404: Is a signal containing valid packet preamble detected? If yes go to Step 406, if no go back to Step 404;

Step 406: Set front-end circuit registers to a setting corresponding to packet decoding mode;

Step 408: Decode received packet;

Step 410: Terminate RX mode? If yes go to Step 412, if no go to Step 402;

Step 412: End.

If the system is initially in a sleeping mood, the front-end circuit registers are set by the MAC 80 to correspond to a lowest SNR level, and the system enters a packet detection mode (e.g. MAC 80 sets the front end circuit registers to low SNR level) if it detects a beacon indicating the arrival of packets. If the system is initially in a packet detection mode, it is set to a setting corresponding to a low SNR level (Step 402). If it is determined that a signal with valid packets is received (Step 404), the front-end circuit registers will be set to a packet decoding mode corresponding to a higher SNR (Step 406) and the received packet will be decoded (Step 408). After the packet is decoded (Step 408), the MAC 80 will set the front-end circuit registers to the packet detection mode (Step 402) if the RX mode has not been terminated (Step 410). Otherwise, if the RX mode has been terminated (Step 410), the RX mode will end (Step 412).

Please note that, in the Rx mode, the front-end circuit register settings can be increased in stages (i.e. steps) during the received preamble, or can jump from a low setting to a high setting directly, and both modifications are covered by the present invention. Furthermore, after the signal part of a data packet is decoded and the modulation scheme therefore determined, the WLAN system 100 can further adjust the front-end circuit register settings to correspond to the exact modulation scheme of the received data packet.

By integrating the front-end and baseband circuits on the same chip, the WLAN system 100 can dynamically alter front-end circuit register settings when the system is in an active Rx or Tx mode. Furthermore, by controlling the SNR the WLAN system 100 is operating at, the power consumption of the system 100 can also be controlled. It should be noted in a case where latency of data delivery between circuits of the WLAN system is negligible due to higher operating clock speed or other improvements, the RF circuit 30, the AFE circuit 50, the baseband circuit 70, and MAC 80 are not limited to be integrated in a single chip.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A WLAN system, comprising:
an Analog Front-End (AFE) circuit, for converting digital baseband data into analog baseband data or converting analog baseband data into digital baseband data;
a Radio Frequency (RF) circuit, coupled to the AFE circuit, for converting the analog baseband data into an RF signal and transmitting the RF signal, or receiving and converting a received RF signal into the analog baseband data; and
a baseband circuit, coupled to the AFE circuit, for processing the digital baseband data and dynamically setting parameters of the AFE circuit, the RF circuit, or both the AFE and RF circuits to adjust a power consumption level according to a content of the digital baseband data.

2. The WLAN system of claim 1, wherein the RF circuit, the AFE circuit, and the baseband circuit are integrated on the same chip.

3. The WLAN system of claim 1, wherein the baseband circuit comprises
a Media Access Control (MAC) circuit for dynamically setting parameters of the AFE circuit, RF circuit, or both AFE and RF circuits to adjust the power consumption level of the WLAN system.

4. The WLAN system of claim 1, wherein the MAC circuit dynamically sets parameters of the RF circuit and the AFE circuit to reduce the power consumption level when no data packets are being transmitted or received, and dynamically sets parameters of the RF circuit and the AFE circuit to increase the power consumption level when data packets are being transmitted or received.

5. The WLAN system of claim 1, wherein the parameters of the RF circuit, AFE circuit, or both the RF and AFE circuits are set to reduce the power consumption level when the WLAN system is transmitting data modulated using a BPSK modulation scheme, and the parameters are set to consume more power when transmitting data modulated using a modulation scheme with a higher rate.

6. The WLAN system of claim 1, wherein the baseband circuit adjusts the parameters in increments.

7. The WLAN system of claim 1, wherein the parameters of the AFE circuit, RF circuit, or both the AFE and RF circuits are set to adjust the power consumption level based on a required SNR level.

8. The WLAN system of claim 1, wherein the content of the digital baseband data comprises an indication of a transmission rate, modulation type, or packet type.

9. The WLAN system of claim 1, wherein the content of the digital baseband data is utilized to set parameters of a pre-amplifier, a mixer, or both the pre-amplifier and mixer in a transmission mode.

10. The WLAN system of claim 1, wherein the content of the digital baseband data is utilized to set parameters of a low noise amplifier (LNA), mixer, synthesizer, or a combination of the LNA, mixer and synthesizer in a receiving mode.

11. The WLAN system of claim 1, wherein the baseband circuit dynamically sets the parameters of the AFE circuit, the RF circuit, or both the AFE and RF circuits to reduce the power consumption level after the digital baseband data has been demodulated.

12. The WLAN system of claim 1, wherein the parameters are dynamically set to reduce the power consumption level when the preamble is received.

13. A method of transmitting data packets over a WLAN network comprising:
dynamically setting at least a transmitting parameter to adjust a power consumption level for transmission;
converting digital baseband data packets into analog baseband data;
converting the analog baseband data into analog RF data; and
transmitting the analog RF data.

14. The method of claim 13 wherein the step of dynamically setting the transmitting parameter comprises:
dynamically setting the transmitting parameters to reduce the power consumption level when no data packets are being transmitted and dynamically setting the transmitting parameter to increase the power consumption level when data packets are being transmitted.

15. The method of claim 13 wherein the transmitting parameter is set to reduce the power consumption level when the WLAN system is transmitting data modulated using a BPSK modulation scheme, and the transmitting parameter is set to consume more power when transmitting data modulated using a modulation scheme with a higher rate.

16. The method of claim 13 wherein the step of dynamically setting the transmitting parameters comprise adjusting the power consumption level in increments.

17. A method for receiving data packets over a WLAN network, the method comprising:
receiving an analog RF data;
dynamically setting the receiving parameters to adjust a power consumption level of signal reception;
converting the analog RF data to analog baseband data; and
converting the analog baseband data to digital baseband data.

18. The method of claim 17 wherein the step of dynamically setting the receiving parameters comprises:
dynamically setting the receiving parameter to reduce the power consumption level when listening to a beacon or before data packets are being detected, and dynamically setting the receiving parameters to increase the power consumption level when data packets are being detected or received.

19. The method of claim 17, wherein the receiving parameter is set to reduce the power consumption level when receiving a preamble, and the receiving parameters are set to consume more power when receiving the data modulating by a high-rate modulation scheme.

20. The method of claim 17, wherein the step of receiving the analog RF data comprises:
receiving a Channel Clear Assignment (CCA) signal for indicating an analog RF data will be received.
